(19) United States
(12) Patent Application Publication
(10) Pub. No.: US 2019/0170208 A1
(43) Pub. Date: Jun. 6, 2019

(54) VOICE COIL ACTUATOR AND SENSING DRIVER MODULE

(71) Applicant: Yun-Hui LIU, Tainan City (TW)

(72) Inventor: Yun-Hui LIU, Tainan City (TW)

(21) Appl. No.: 15/829,414

(22) Filed: Dec. 1, 2017

(51) Int. Cl. F16F 15/00; H02K 41/035; H02K 11/21

(52) U.S. Cl. CPC F16F 15/005; H02K 11/21; H02K 41/0356

(57) ABSTRACT

A voice coil actuator and a sensing driver module are provided. A cover body of the voice coil actuator is connected with a body base to form receiving space. A magnetic element is arranged in the receiving space. A rotor assembly has a rotor, a first elastic element and a pressing element. the rotor is arranged opposite to the magnetic element and has a hole and a first side, the pressing element is arranged in the hole, a first end of the pressing element is curved and protrudes beyond the hole, the first elastic element is arranged on the first side, a third end of the first elastic element abuts against the magnetic element, and a fourth end is located in the hole and abuts against a second end of the pressing element. A coil is connected with the rotor.

### BACKGROUND OF THE INVENTION

### Field of the Invention

The present invention relates to an actuator and a sensing driver module, and more particularly to a voice coil actuator and a sensing driver module.

### Description of the Prior Art

Usually, a vibration isolating system is widely used in all types of mechanical devices, and as the technology improves, the industry develops more and more dedicated and tiny devices. To keep the dedicated elements from influence of vibration during a processing process and from decreasing precision, a vibration isolating with more preferable vibration isolating effect is developed and manufactured.

In addition, since the semi-conductor manufacturing process advances toward the nano level, and the demand for floor vibration isolation becomes higher, traditional vibration isolation technology is gradually out of date. Therefore, many international advanced vibration isolation related companies start developing proactive vibration isolating technology so as to help the development of hi-tech nano equipment. A proactive vibration isolating system uses a vibration detecting device to catch a vibration signal so as to conduct a close loop feedback control, outputs an actuating signal to drive an actuating element so as to provide additional force to suppress the vibration, and further reach the goal of decreasing the amount of vibration and elevating the manufacturing yield.

A voice coil actuator has small volume, precise actuating movement and reasonable price, so the voice coil actuator has become the product which is used by the most companies among the other actuating elements in the proactive vibration isolation system. However, in one of the conventional voice coil actuator, a voice coil rotor and a voice coil main body are connected to each other via an elastic plate, because the elastic plate is more rigid, a rigidity of the whole proactive vibration isolating system also increases. Therefore, when the voice coil actuator is impacted by an overly great force (for example, an overly great vibration force), the voice coil may be damaged due to the elastic plate hitting a bottom portion of the voice coil.

Therefore, how to provide a voice coil actuator and a sensing driver module which can prevent the coil from damage due to great vibration has become an issue that the industry needs to work on.

The present invention has arisen to mitigate and/or obviate the afore-described disadvantages.

### SUMMARY OF THE INVENTION

The major object of the present invention is to provide a voice coil actuator and a sensing driver module which can be adapted to a proactive vibration isolating system. The voice coil actuator and the sensing driver module can not only prevent a coil from being damaged due to a force which is too great but also lower a cost of the proactive vibration isolating system so as to increase a competitiveness of the product.

To achieve the above and other objects, a voice coil actuator is provided, including a main body, a cover body, a magnetic element, a rotor assembly and a coil. The cover body is connected to the body base to form a receiving space. The magnetic element is arranged within the receiving space. The rotor assembly is arranged within the receiving space, the rotor assembly has a rotor, a first elastic member and a pressing element, the rotor is arranged opposite to the magnetic element and has a hole and a first side, the pressing element is arranged in the hole and has a first end and a second end which is opposite to the first end, the first end is curved and protrudes beyond the hole, the first elastic element is arranged on the first side and has a third end and a fourth end which is opposite to the third end, the third end abuts against the magnetic element, and the fourth end is located within the hole and abuts against the second end. The coil is annularly arranged around a circumference of the magnetic element and connected to the rotor.

To achieve the above and other objects, a sensing driver module is provided, including a voice coil actuator and an accelerometer. The voice coil actuator includes a main body, a cover body, a magnetic element, a rotor assembly and a coil. The cover body is connected to the body base to form a receiving space. The magnetic element is arranged within the receiving space. The rotor assembly is arranged within the receiving space, the rotor assembly has a rotor, a first elastic member and a pressing element, the rotor is arranged opposite to the magnetic element and has a hole and a first side, the pressing element is arranged in the hole and has a first end and a second end which is opposite to the first end, the first end is curved and protrudes beyond the hole, the first elastic element is arranged on the first side and has a third end and a fourth end which is opposite to the third end, the third end abuts against the magnetic element, and the fourth end is located within the hole and abuts against the second end. The coil is annularly arranged around a circumference of the magnetic element and connected to the rotor. The accelerometer is tightly fitted into the voice coil actuator, and the accelerometer is for measuring an axial vibration and outputting a vibration signal; wherein the voice coil actuator controls the rotor assembly to move according to the vibration signal so as to counter the axial vibration.

In an embodiment, the voice coil actuator further includes a yoke and a positioning frame. The yoke is arranged within the receiving space and annularly arranged around the circumference of the magnetic element, and the coil is located between the magnetic element and the yoke. The positioning frame is connected to the cover body and the yoke, and the rotor assembly is located by an inner side of the positioning frame.

In addition, the voice coil actuator further includes a supporting element and a packing element. The supporting element is annularly arranged around a circumference of the rotor, and the supporting element is respectively connected to the rotor and the positioning frame. The packing element is arranged by an inner side of the positioning frame, and the supporting element is sandwiched between the positioning frame and the packing element.

In an embodiment, the rotor assembly further has a ball, a locking element and a second elastic element, at least one lateral side of the rotor has a through hole, the ball is arranged within the through hole and abuts against a groove on a side of the pressing element, the locking element is arranged within and tightly fitted into the through hole, and the second elastic element is arranged between the ball and the locking element.

In an embodiment, the accelerometer has a base, a mass block, at least three elastic element sets, a piezoelectric element and a first damping element, the base has a pressing portion on the axial direction, the mass block has a first side and a second side which is opposite to the first side, each of the at least three elastic element sets includes a first elastic element, a second elastic element and a prepressing adjusting element, the first elastic element is arranged on the first side of the mass block, the second elastic element is arranged on the second side of the mass block, the prepressing adjusting element is disposed through the first elastic element, the mass block and the second elastic element, the piezoelectric element is arranged between the mass block and the base, the piezoelectric element has a first side which is toward the pressing portion and a second side which is opposite to the first side, the first damping element is arranged on at least one of two sides of the piezoelectric element, and when the mass block moves on the axial direction, the pressing portion of the base make the piezoelectric element produce a deformation.

In an embodiment, a side of the body base has at least three protrusions and a recess, the accelerometer is tightly fitted into the recess, and the at least three protrusions are evenly arranged.

Given the above, in the voice coil actuator and the sensing driver module, the accelerometer is tightly fitted into the voice coil actuator; the cover body and the body base of the voice coil actuator are connected to each other to form the receiving space, the first end of the pressing element of the rotor assembly is curved and protrudes beyond the hole, the third end of the first elastic element abuts against the magnetic element, the fourth end of the first elastic element is located in the hole and abuts against the second end of the pressing element, the coil is annularly arranged around the circumference of the magnetic element and connected to the rotor; the accelerometer is for measuring the axial vibration and outputting the vibration signal, and the voice coil actuator can control the rotor assembly to move according to the vibration signal so as to counter the axial vibration. Through the above-mentioned structure, the voice coil actuator and the sensing driver module can prevent the coil from being damaged due to overly great force and lower the cost of the proactive vibration isolating system so as to increase the competitiveness of the product.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1A to 1C are respectively assembly, breakdown and cross-sectional views of a sensing driver module of a preferred embodiment of the present invention;

FIGS. 2A to 2C are respectively stereogram, cross-sectional and breakdown views of an accelerometer; and

FIGS. 3A to 3C are respectively stereogram, cross-sectional and breakdown views of a voice coil actuator of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

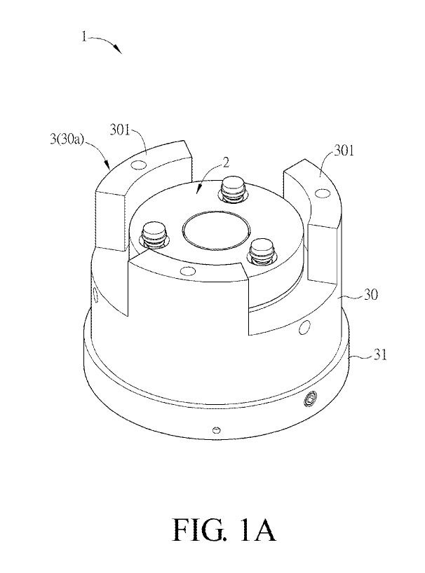

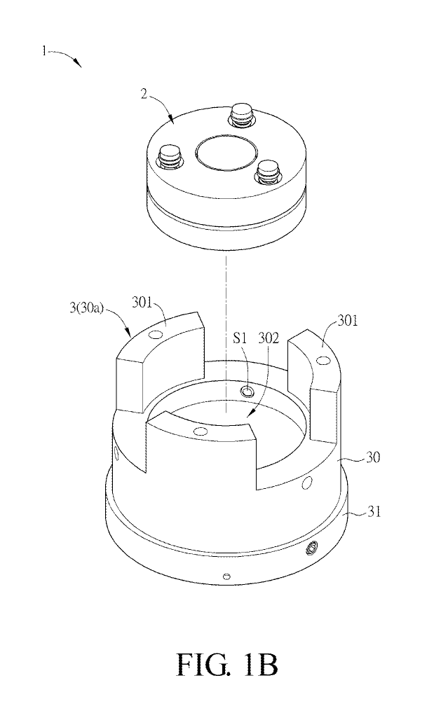

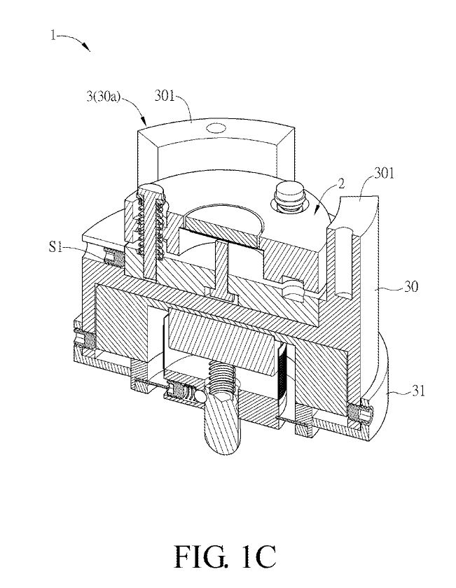

Please refer to FIGS. 1A to 1C for respectively assembly, breakdown and cross-sectional views of a sensing driver module 1 of a preferred embodiment of the present invention.

The sensing driver module 1 can be adapted to a proactive vibration isolating system and includes an accelerometer 2 and a voice coil actuator 3. The accelerometer 2 is for measuring an axial vibration and outputting a vibration signal, the proactive vibration isolating system can calculate and convert the vibration signal and provides the vibration signal converted to the voice coil actuator 3, and the voice coil actuator 3 can output a counterforce according to the vibration signal to counter the axial vibration. In some embodiments, the proactive vibration isolating system may include a plurality of sets of sensing driver module 1, the sensing driver modules 1 may be respectively assembled on X axis, Y axis and Z axis, the accelerometers 2 on at least three directions can respectively measure the accelerated velocities of the three axes, the at least three voice coil actuators 3 corresponded can output counter forces on the three axes to respectively counter vibrations on the three axes so as to suppress an object to be measured or an object to be isolated from vibration to decrease vibration. The sensing driver module 1 may also be used on monitoring an industrial production line, earthquake monitoring, measuring microvibration of floors of semi-conductor or optoelectronics factories or other vibration suppressions, but not limited thereto.

In the embodiment, the voice coil actuator 3 has a body base 30, and the accelerometer 2 is tightly fitted into the voice coil actuator 3. A side 30a of the body base 30 has at least three protrusions 301 and a recess 302, and the accelerometer 2 is tightly fitted into the recess 302; that is, the accelerometer 2 is tightly placed in and connected to the recess 302. In addition, to increase a connection strength, at least one connecting element S1 (for example, a screw) is disposed through a hole of the body base 30 to be fixedly screwed with the accelerometer 2 to enhance the connection strength. Moreover, a number of the protrusions 301 is three, and the protrusions 301 are evenly arranged on the side 30a of the body base 30. With the protrusions 301, the accelerometer 2 can be easily assembled in the recess 302 of the voice coil actuator 3, and the accelerometer 2 can be easily separated from the voice coil actuator 3.

Please refer to related Figs. to see details of structures of the accelerometer 2 and the voice coil actuator 3.

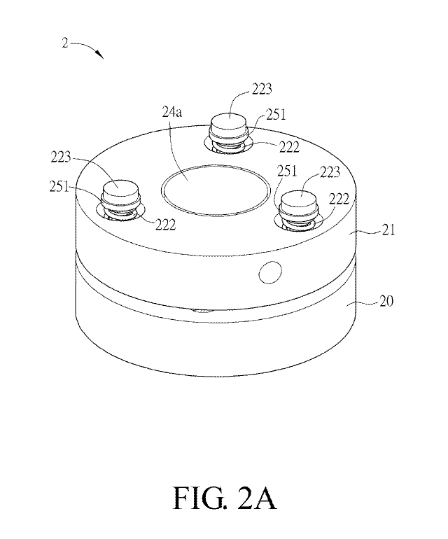

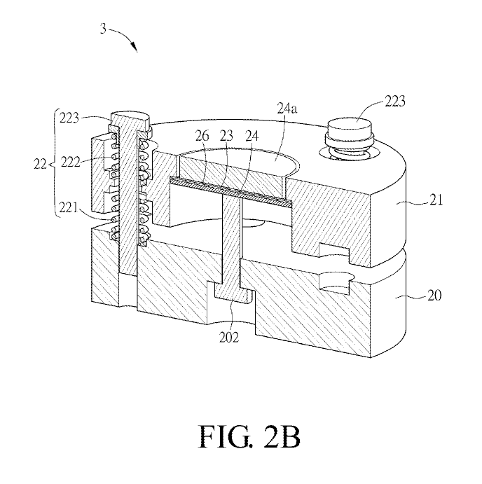

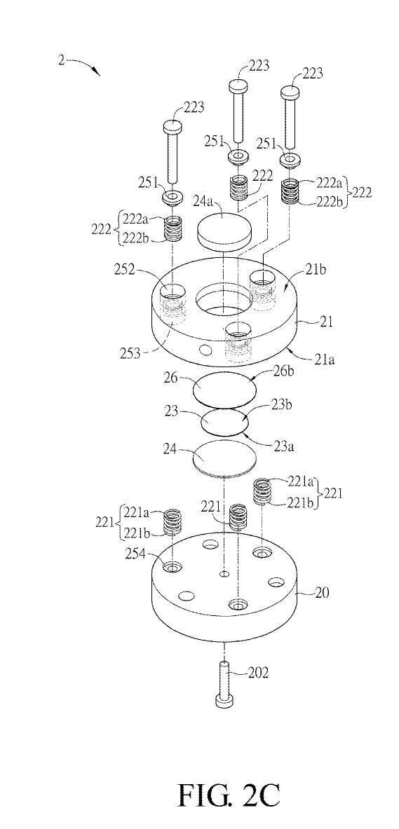

Please refer to FIGS. 2A to 2C respectively for stereogram, cross-sectional and breakdown views of the accelerometer 2.

The accelerometer 2 of the present invention is design to measure a vibration in itself which is under ⅓ of the natural frequency, and under the circumstance that a rigid element is a copper sheet, a measurable range is preferably 1 Hz to 40 Hz.

The accelerometer 2 is for measuring the accelerated velocity of an axial direction. In other words, the accelerometer 2 is a uniaxial accelerometer, for example, the accelerometer arranged on the X-Y plane (horizontal plane) can measure an accelerated motion on Z direction (vertical direction). Of course, the accelerometer arranged on X-Z plane can measure accelerated motion on Y direction, and so on.

The accelerometer 2 includes a base 20, a mass block 21, at least three elastic element sets 22, a piezoelectric element 23 and a first damping element 24. The base 20 has a pressing portion 202 on the axial direction (Z direction), so a direction that the pressing portion 202 is arranged must be the same as an accelerated velocity direction that the accelerometer 2 wants to measure. Although the pressing portion 202 of the present invention is locked on the base 20 (the pressing portion 202 may be a top pin or a screw), in different embodiments, the pressing portion 202 and the base 20 may be integrally formed as long as the pressing portion 202 protrudes beyond a surface of the base 20 and abuts against a part of the piezoelectric element 23. In addition, the pressing portion 202 may be in shapes of cylinder, rectangular prism or hexagonal prism, and the shapes are not limited to the shapes or arrangements of the Figs. of the embodiment.

For more detail of positions of the elements, the mass block 21 which is arranged above the base 20 has a first side 21a and a second side 21b which is opposite to the first side 21a, and the first side 21a of the mass block 21 is neighboring to the base 20.

Each of the at least three elastic element sets 22 includes a first elastic element 221, a second elastic element 222 and a prepressing adjusting element 223. The first elastic element 221 has first end 221a and a second end 221b which is opposite to the first end 221a. The second elastic element 222 has a first end 222a and a second end 222b which is opposite to the first end 222a. The first elastic element 221 is arranged on the first side 21a of the mass block 21, the second elastic element 222 is arranged on the second side 21b of the mass block 21. In addition, the prepressing adjusting element 223 is disposed through the first elastic element 221, the mass block 21 and the second elastic element 222. Each said prepressing adjusting element 223 corresponds to each said first elastic element 221 and each said elastic element 222 and sequentially through the mass block 21, each said first elastic element 221 and each said elastic element 222 and the base 20. With the arrangement of the first elastic element 221 and the second elastic element 222, the base 20 and the mass block 21 can move simultaneously and coaxially and provide precise vibration signals. Through adjusting a distance between the prepressing adjusting element 223 and the base 20, the mass block 21 presses the first elastic element 221 and each said elastic element 222 to make the first and second elastic elements of the elastic element set 22 to be prepressed so that a user can adjust a distance between the mass block 21 and the base 20 to abut the pressing portion 202 to a predetermined position.

In addition, the prepressing adjusting element 223 can also make the pressing portion 202 of the base 20 to prepress the piezoelectric element 23. When the piezoelectric element 23 receives a preload force, the piezoelectric element 23 can be ensured to be pressed by a force during a measuring process (the piezoelectric element 23 and the pressing portion 202 will not be separated from each other and unable to measure vibration) to decrease error of measurement. It is to be noted that a prepressing depth may need to be adjusted according to difference materials or structures, if the prepressing depth is too small, the pressing portion 202 may be unable to contact the piezoelectric element 23 during the measuring process and unable to get correct measuring data; but if the prepressing depth is too great, the piezoelectric element 23 may undergo plastic deformation or be broken. In this embodiment, a prepressing distance between the pressing portion 202 and the piezoelectric comment 23 is, for example, 0.75 mm.

It is to be noted that in this embodiment, the three elastic element sets 22 have the same heights and are respectively, spacingly and evenly arranged, so the elastic element sets 22 can provide the mass block 21 with a force on a Z direction (vertical direction) (on the contrary, each of the three elastic element sets 22 receives a same weight from the mass block 21), and the mass block 21 and the base 20 are arranged in parallel. In other embodiments, a number of the elastic element sets may be adjusted as long as the mass block 21 receives a force evenly, and the mass block 21 and the base 20 can be arranged in parallel.

Aside from arrangement, in this embodiment, two ends of the elastic element sets 22 are flattened. In other words, two ends of each said first elastic element 221 and each said second elastic element 222 which respectively contact the mass block 21 and the base 20 are flattened so that the mass block 21 can be arranged parallel to the base 20, and an overall measuring precision can be increased. Specifically, being flattened here means that the first and second elastic element 221, 222 are cut flat in accordance with surfaces of the mass block 21 and the base 20 to make the first and second elastic element 221, 222 to be perpendicular to the flattened part. In addition, when being free of force, the first elastic element 221 will make the mass block 21 in a state that resultant force is zero (the mass block 21 can levitate). In this embodiment, each of the first and second elastic elements 221, 222 is a spring, and the springs have the same length; but in other embodiments, each of the first and second elastic elements 221, 222 may also be an elastic piece or other elastic elements.

To cooperate with the at least three elastic element sets 22 mentioned above, in this embodiment, the accelerometer 2 may further include at least three fixing elements 251, at least three first fixing seats 252, at least three second fixing seats 253 and at least three third fixing seats 254 for the at least three elastic element sets 22 to be arranged therein. Here, three said fixing elements 251, three said first fixing seats 252, three said second fixing seats 253 and three said third fixing seats 254 are used to cooperate with three said elastic element sets 22.

The first fixing seats 252 are provided on the second side 21b of the mass block 21, the second fixing seats 253 are provided on the first side 21a of the mass block 21, and the third fixing seats 254 are provided on a side of the base 20 facing the mass block 21. In this embodiment, the first fixing seat 252, the second fixing seat 253 and the third fixing seat 254 may be integrally formed with the mass block 21 or the base 20, but in other embodiments, the first fixing seat 252, the second fixing seat 253 and the third fixing seat 254 may also be independent from the mass block 21 or the base 20.

Specifically, the first end 222a of the second elastic element is sleeved on the fixing element 251, the first elastic element 221 is sandwiched between the second fixing seat 253 and the third fixing seat 254, and the second elastic element 222 is sandwiched between the fixing element 251 and the first fixing seat 252. In addition, the prepressing adjusting element 223 is disposed through the fixing element 251, the second elastic element 222, the first fixing seat 252, the second fixing seat 253, the first elastic element 221 and the third fixing seat 254.

The fixing element 251, the first fixing seat 252, the second fixing seat 253 and the third fixing seat 254 are provided so that the elastic element sets 22 will deviate, during a process of measuring the accelerated velocity, the elastic element sets 22 will not be displaced or skewed, and the elastic element sets 22 can be prevented from swinging so as to ensure the measurement data to be more precise.

The piezoelectric element 23 is arranged between the mass block 21 and the base 20. Specifically, the piezoelectric element 23 has a first side 23a and a second side 23b which is opposite to the first side 23a, and the first side 23a of the piezoelectric element 23 is arranged relative to the pressing portion 202.

The chart below shows the piezoelectric element 23 and other material parameters that could be used, but not limited thereto.

| | | Young's | |
|---|---|---|---|
| | Density | coefficient | |
| | (Kg/m³) | (N/m²) | Poisson's ratio |
| C3604 | 8500 | 9.7 × 10¹⁰ | 0.31 |
| PZT-5H | 7700 | 5.1 × 10¹⁰ | 0.31 |
| PDMS4207 | 980 | 0.4 × 10⁶ | 0.5 |
| SUS304 | 8000 | 19 × 10¹⁰ | 0.29 |
| SCM435 | 8000 | 21 × 10¹⁰ | 0.3 |

In addition, the accelerometer 2 may further include a rigid element 26 (for example, a metal sheet), and the rigid element 26 is arranged on the second side 23b of the piezoelectric element 23. The rigid element 26 is provided to increase a rigidity of the piezoelectric element 23. For example, the rigid element 26 can be attached to one of two sides of the piezoelectric element 23 which is opposite to the other of the two sides that is pressed (the rigid element 26 can be attached to a negative pole of the piezoelectric element 23 via an epoxy resin) to increase the rigidity of the piezoelectric element 23 and to prevent the piezoelectric element 23 from being broken. The rigid element 26 is also provided to increase a rigidity of the mass block 21. Therefore, when a supporting rigidity of the mass block 21 increases, the overall natural frequency of the accelerometer 2 will also increase so that a bandwidth that the accelerometer 2 can measure will be greater. In addition, the accelerometer 2 can adjust the overall natural frequency through increasing a thickness or a number of the rigid element 26.

More specifically, this embodiment takes a piezoelectric element 23 and a rigid element 26 as an example, but the user can pile up a piezoelectric element 23 and different numbers of rigid elements in accordance to different requirements to achieve various measuring goals. The chart below is a possible example of an examination, and “thickness” in the chart is the thickness that the rigid element 26 and the piezoelectric element 23 are piled up. In addition, the rigid element 26 in the chart is a thin copper sheet.

| | One rigid element | | Two rigid | | Three rigid | |
|---|---|---|---|---|---|---|
| | with one | | elements with one | | elements with one | |
| | piezoelectric | | piezoelectric | | piezoelectric | |
| | element | | element | | element | |
| Thickness | 0.43 | mm | 0.74 | mm | 0.95 | mm |
| Natural | 170.5 | Hz | 299.5 | Hz | 385.5 | Hz |
| frequency | | | | | | |
| Sensitivity | 82.5 | V/g | 56.5 | V/g | 36.8 | V/g |
| (±10%) | | | | | | |
| Bandwidth | 2~52 | Hz | 2~96 | Hz | 1~153 | Hz |
| (±10%) | | | | | | |
| Bandwidth | 0.75-92 | Hz | 0.75-169 | Hz | 0.25-237 | Hz |
| (±3 dB) | | | | | | |

The first damping element 24 is attached on the first side 23a of the piezoelectric element 23. In other words, in this embodiment, the first damping element 24 is arranged between the mass block 21 and the base 20 and on the first side 23a of the piezoelectric element 23. Specifically, the first damping element 24 is arranged between the piezoelectric element 23 and the pressing portion 202 of the base 20. The first damping element 24 may be made of rubber, silica gel, elastopolymer or other compounds, but not limited thereto. In actual practice, the material of which the first damping element 24 is made can be adjusted according to different requirements. The first damping element 24 can not only adjust a damping coefficient of the accelerometer 2 but also increase a damping coefficient of the whole invention to make the frequency that responses to be flatter, so the measurable bandwidth range becomes wider. In addition, the first damping element 24 may also function as the pressing portion 202 which isolates the base 20 to prevent the base 20 from contacting the piezoelectric element 23 so as to prevent the piezoelectric element 23 from short-circuit or damage.

In different embodiments, the first damping element 24 and the rigid element 26 may also be arranged on the second side 23b of the piezoelectric element 23 (not shown). Specifically, the first damping element 24 may be arranged above the rigid element 26 (that is, the rigid element 26 is arranged between the first damping element 24 and the piezoelectric element 23) to counter a resonance of the rigid element 26. If the first damping element 24 is arranged on the first side 23a of the piezoelectric element 23, the resonance of the rigid element 26 can be countered. Although both the two arrangement ways mentioned above influence the sensitivity of the accelerometer, the bandwidth that is measurable increases. Therefore, preferably, the user needs to choose an appropriate damping parameter (that is, to choose the first damping element 24 with appropriate width or hardness) so as to reach the bandwidth and bandwidth s/he wants.

In addition, in this embodiment, the accelerometer 2 further includes a second damping element 24a, and the second damping element 24a is arranged on one of two sides of the rigid element 26 opposite to the piezoelectric element 23. The first damping element 24 is arranged between the piezoelectric element 23 and the pressing portion 202, and the second damping element 24a is arranged on the second side 26b of the rigid element 26. In other words, in this embodiment, each of the two sides of the rigid element is provided with a damping element 24, 24a.

Therefore, this embodiment has a simple structure (less elements) and is easy to be assembled, so the accelerometer 2 has lower cost. Besides, during the actual process of operating the accelerometer 2, when the mass block 21 moves on the axial direction due to vibration, the pressing portion 202 of the base 20 makes the piezoelectric element 23 produce a deformation. Then, the accelerometer 2 converts the deformation to an electric signal (or an electric charge signal or a vibration signal) and transmits the electric signal to the vibration isolating system that the accelerometer 2 cooperates with, after the electric signal is calculated and converted and then provided to the voice coil actuator 3, and the voice coil actuator 3 can output a counterforce according to the vibration signal to counter the vibration of the axial direction.

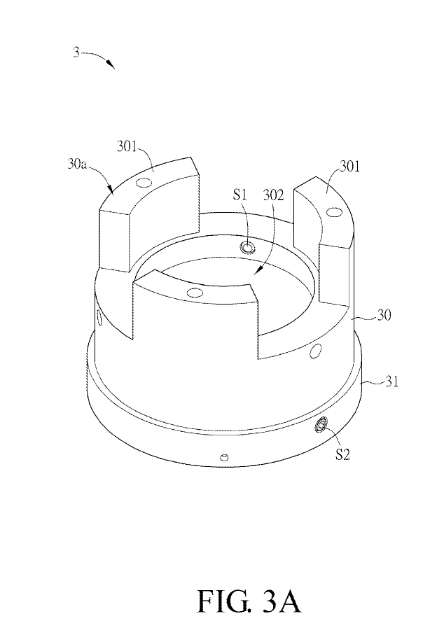

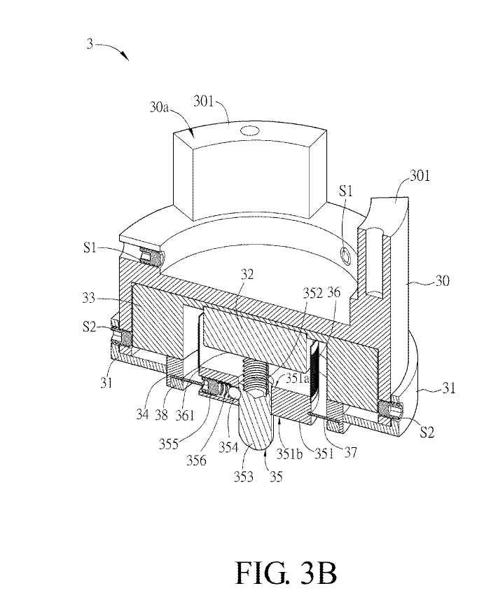

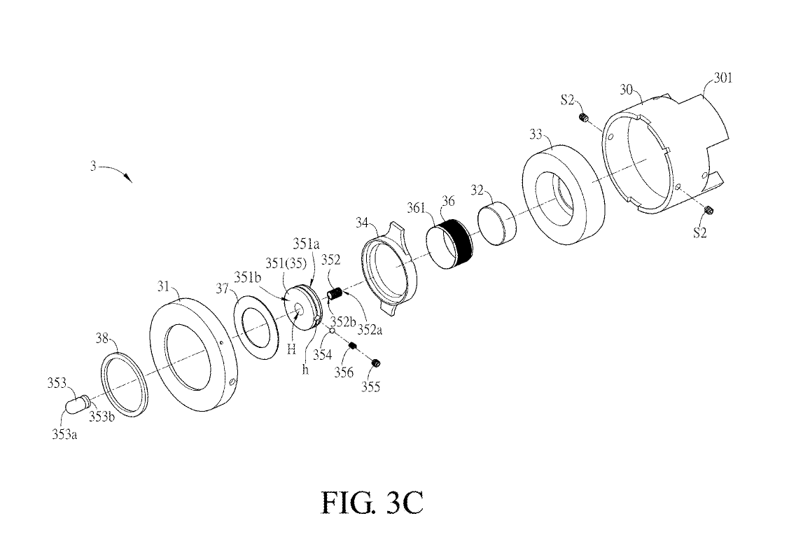

Please refer to FIGS. 3A to 3C for stereogram, cross-sectional and breakdown views of the voice coil actuator 3 of an preferred embodiment.

In this embodiment, the voice coil actuator 3 has a body base 30, and the accelerometer 2 is tightly fitted into the voice coil actuator 3. A side 30a of the body base 30 has at least three protrusions 301 and a recess 302, and the accelerometer 2 is tightly fitted into the recess 302. In addition, to increase the connection strength, at least one connecting element S1 (for example, a screw) is further disposed through a hole of the body base 30 to be fixedly screwed with the accelerometer 2. In this embodiment, a number of the protrusions is three, and the protrusions are evenly arranged on the side 30a of the body base 30. Through the protrusions 301, the accelerometer 2 can be easily assembled in the recess 302 of the voice coil actuator 3 to make the accelerometer 2 separate from the voice coil actuator 3 easily. More specifically, the voice coil actuator 3 further includes a cover body 31, a magnetic element 32, a yoke 33, a positioning frame 34, a rotor assembly 35 and a coil 36. In this embodiment, the voice coil actuator 3 further includes a supporting element 37 and a packing element 38. The body base 30, the cover body 31, the positioning frame 34, the rotor assembly 35 and the packing element 38 may be made of metals (for example, stainless steel) to elevate the overall structural strength.

As shown in FIG. 3B, the cover body 31 is connected to the body base 30 to form a receiving space (not marked in FIG. 3B). In this embodiment, lateral sides of the cover body 30 and the body base 31 respectively correspond to at least one piercing hole (not marked in FIG. 3B), and at least one connecting element S2 (for example, a screw) is disposed through the at least one piercing hole to fixedly screw the cover body 31 and the body base 30 correspondingly to make the cover body 31 and the body base 30 connected to each other. In this embodiment, a number of the connecting element is two, but the number of the connecting element can be adjusted as long as the cover body 31 and the body base 30 can be tightly connected to each other.

The magnetic element 32 and the yoke 33 are both arranged within the receiving space, and the coil 36 is located between the magnetic element 32 and the yoke 33 (the coil 36 does not contact the magnetic element 32 and the yoke 33 directly). As shown in FIG. 3C, the magnetic element is a cylindrical permanent magnet, the yoke 33 is made of a magnetic material, and the yoke 33 is annularly arranged around a circumference of the magnetic element 32 (that is, the magnetic element 32 is located in an inner ring of the yoke 33) so as to guide and change magnetic orientations of the coil 36 and the magnetic element 32.

The positioning frame 34 is connected to the cover body 31 and the yoke 33, and the rotor assembly 35 is located by an inner side of the positioning frame 34. The yoke 33 and the magnetic element 32 are located the receiving space which is formed by the body base 30, the cover body 31 and the positioning frame 34, the positioning frame 34 positions the coil 36 to keep a gap between the magnetic element 32 and the coil 36, and the coil 36 and the yoke 33 also have a gap therebetween to prevent the coil from contacting the yoke 33 and the magnetic element 32 directly.

The rotor assembly 35 is arranged within the receiving space. In this embodiment, the rotor assembly 35 includes a rotor 351, a first elastic member 352 and a pressing element 353, and the rotor 351, the first elastic element 352 and the pressing element 353 are located by an inner side of the positioning frame 34. In this embodiment, the rotor assembly 35 may further include a ball 354, a locking element 355 and a second elastic element 356.

The rotor 351 is arranged opposite to the magnetic element 32. Being opposite means that the rotor 351 and the magnetic element 32 have similar shapes (both are cylindrical) and are arranged face-to-face. The rotor 351 has a hole H (not shown in FIGS. 3A and 3B), a first side 351a and a second side 351b. The first side 351a is a side of the rotor 351 facing the magnetic element 32, and the second side 351b is an opposite side of the first side 351a.

The pressing element 353 is arranged in the hole H and has a first end 353a and a second end 353b which is opposite to the first end 353a (not shown in FIGS. 3A and 3B), and the first end 353a is curved and protrudes beyond the hole H. The pressing element 353 may be a top rail (or a top pin), the first end 353 a is curved so that the pressing element 353 point contacts with an object, and when the pressing element 353 contacts the object, if the first end 353a contacts the object in other angles other than 90 degrees, the coil 36 can prevent from being skewed (deviated from the direction of Z-axis).

The first elastic element 352 is arranged on the first side 351a of the rotor 351 and has a third end 352a and a fourth end 352b which is opposite to the third end 352a (not shown in FIGS. 3A and 3B). The third end 352a abuts against the magnetic element 32, and the fourth end 352b is located within the hole H and abuts against and connected to the second end 353b of the pressing element 353. The first elastic element 352 is for providing an elasticity so that when a vertical force exerted on the pressing element 353 disappears, the pressing element 353 can push outward to return the rotor assembly 35 back to an original state.

The coil 36 is annularly arranged on the circumference of the magnetic element 32 and connected to the rotor assembly 35. In this embodiment, the coil 36 surrounds an circumference of a fixing ring 361 (for example, a copper ring) and is connected to the rotor 351 via the fixing ring 361. Specifically, to reinforce a connection strength of the coil 36 and the rotor 351, in this embodiment, the rotor 351 and an inner ring of the fixing ring 361 are glued to each other with an adhesive. Therefore, when the rotor 351 moves, the fixing ring 361 and the coil 36 are driven to move; and when the fixing ring 361 and the coil 36 move, the rotor 351 is also driven to move.

In addition, in this embodiment, at least one lateral side of the rotor 351 has a through hole h (not shown in FIGS. 3A and 3B), and the ball 354 is arranged within the through hole h and abuts against a groove on a side of the pressing element 353 (because the Figs. are too complicated, the groove in FIG. 3B is not numbered). The ball 354 may be a steel ball, and through engaging the ball 354 into the groove on the lateral side of the pressing element 353, a connection strength of the rotor 351 and the pressing element 353 can be increased. Specifically, the locking element 355 is arranged within and tightly fitted into the through hole h. The locking element 355 is a screw, and the through hole h has a threaded portion correspond to the screw so that the locking element 355 can be screwed within the through hole h and tightly connected to the through hole h. More specifically, the second elastic element 356 is arranged between the ball 354 and the locking element 355, one of two ends of the second elastic element 356 abuts against the ball 354, the other of the two ends of the second elastic element 356 abuts against the locking element 355. Therefore, through lateral forces that the locking element 355 and the second elastic element 356 exert on the ball 354, relative positions of the rotor 351 and the pressing element 353 can be fixed.

The supporting element 37 may be a rubber ring which is elastic, and the supporting element 37 is annularly arranged around a circumference of the rotor 351 and respectively connected to the rotor 351 and the positioning frame 34 to provide a buffer effect when the rotor assembly 35 moves. In this embodiment, to reinforce the connection strength of the supporting element 37 and the rotor 351, an inner ring of the supporting element 37 is engaged in an outer ring of the rotor 351, and the supporting element 37 and the rotor 351 are glued to each other via an adhesive so that the supporting element 37 is fixed between the rotor 351 and the positioning frame 34 to provide a buffer effect. In addition, the packing element 38 is arranged on an inner side of the positioning frame 34, and the supporting element 37 is sandwiched between the positioning frame 34 and the packing element 38. The packing element 38 is a packing ring and arranged on the inner side of the positioning frame 34 so that the packing element 38 and the positioning frame 34 can clamp the outer ring of the supporting element 37, and the supporting element 37 can fix relative positions of the rotor 351 and the coil 36 and relative positions of the rotor 351 and the positioning frame 34.

As shown in FIG. 3B, through lateral forces from the locking element 355, the second elastic element 356 and the ball 354, the relative positions of the rotor 351 and the pressing element 353 can be fixed. Therefore, when a vertical force (on Z-axis) that the pressing element 353 receives is greater than a critical force that the voice coil actuator 3 can endure, the rotor assembly 35 can retract toward the magnetic element 32 via the first elastic element 352 to prevent the coil 36 from hitting the magnetic element 32 or the yoke 33 when the rotor 353 retracts and drives the coil 36 to move.

In addition, when the accelerometer 2 detects the axial vibration and outputs the vibration signal, the proactive vibration isolating system can calculate and convert the vibration signal and provides the vibration signal converted to the voice coil actuator 3, and the voice coil actuator 3 can control the rotor assembly 35 (or the rotor 351) to move according to the vibration signal so as to output the counterforce to counter the axial vibration. Therefore, when the voice coil actuator 3 outputs the counterforce according to the vibration signal to counter the axial vibration (for example, Z-axis), the magnetic element 32 and the coil 36 move relative to each other due to interactivity of the magnetic force. Since the magnetic element 32 is fixed on the yoke 33, the coil (and the fixing ring 361) will move up and down (to balance the vibration of Z-axis) so as to drive the rotor 351 to move up and down to counter the axial vibration.

It is to be noted that if the voice coil actuator 3 is used to counter the vibration on Z-axis, the rotor 351 is less like to tilt laterally because the rotor 351 is put on a horizontal direction (for example, on X-Y plane). However, when a user wants to balance the vibration from the horizontal direction, the rotor 351 should be put straight. Therefore, when the rotor 351 is free from force, the rotor 351 cannot tilt, or the rotor 351 may tilt laterally; and when the rotor 351 moves to counter the vibration, there may be error, and the precision of the proactive vibration isolating system may also be influenced. Through computational simulation, a center of gravity of the rotor 351 is precisely designed and controlled to solve the problem that the rotor 351 tilts laterally.

Given the above, in the voice coil actuator and the sensing driver module, the accelerometer is tightly fitted into the voice coil actuator. The cover body of the voice coil actuator is connected to the body base to form a receiving space, the first end of the pressing element of the rotor assembly is curved and protrudes beyond the hole, the third end of the first elastic element abuts against the magnetic element, the fourth end of the first elastic element is located in the hole and abuts against the second end of the pressing element, and the coil is annularly arranged around the circumference of the magnetic element and connected to the rotor. In addition, the accelerometer is used to detect an axial vibration and outputs a vibration signal, and the voice coil actuator can control the rotor assembly to move according to the vibration signal to counter the axial vibration. Through the above-mentioned structure, the voice coil actuator and the sensing driver module can not only prevent the coil from being damaged due to a force which is too great but also lower a cost of the proactive vibration isolating system so as to increase a competitiveness of the product.

While we have shown and described various embodiments in accordance with the present invention, it should be clear to those skilled in the art that further embodiments may be made without departing from the scope of the present invention.

What is claimed is:

1. A voice coil actuator, including:
a body base;
a cover body, connected to the body base to form a receiving space;
a magnetic element, arranged within the receiving space;
a rotor assembly, arranged within the receiving space, having a rotor, a first elastic member and a pressing element, the rotor being arranged opposite to the magnetic element and having a hole and a first side, the pressing element being arranged in the hole and having a first end and a second end which is opposite to the first end, the first end being curved and protruding beyond the hole, the first elastic element being arranged on the first side and having a third end and a fourth end which is opposite to the third end, the third end abutting against the magnetic element, the fourth end being located within the hole and abutting against the second end; and
a coil, annularly arranged around a circumference of the magnetic element and connected to the rotor.

2. The voice coil actuator of claim 1, further including:
a yoke, arranged within the receiving space and annularly arranged around the circumference of the magnetic element, the coil being located between the magnetic element and the yoke; and
a positioning frame, connected to the cover body and the yoke, the rotor assembly being located by an inner side of the positioning frame.

3. The voice coil actuator of claim 2, further including:
a supporting element, annularly arranged around a circumference of the rotor, respectively connected to the rotor and the positioning frame; and
a packing element, arranged by an inner side of the positioning frame, the supporting element being sandwiched between the positioning frame and the packing element.

4. The voice coil actuator of claim 3, wherein the rotor assembly further has a ball, a locking element and a second elastic element, at least one lateral side of the rotor has a through hole, the ball is arranged within the through hole and abuts against a groove on a side of the pressing element, the locking element is arranged within and tightly fitted into the through hole, and the second elastic element is arranged between the ball and the locking element.

5. A sensing driver module, including:
a voice coil actuator, having:
a body base;
a cover body, connected to the body base to form a receiving space;
a magnetic element, arranged within the receiving space;
a rotor assembly, arranged within the receiving space, having a rotor, a first elastic member and a pressing element, the rotor being arranged opposite to the magnetic element and having a hole and a first side, the pressing element being arranged in the hole and having a first end and a second end which is opposite to the first end, the first end being curved and protruding beyond the hole, the first elastic element being arranged on the first side and having a third end and a fourth end which is opposite to the third end, the third end abutting against the magnetic element, the fourth end being located within the hole and abutting against the second end; and
a coil, annularly arranged around a circumference of the magnetic element and connected to the rotor;
an accelerometer, tightly fitted into the voice coil actuator, the accelerometer for measuring an axial vibration and outputting a vibration signal;
wherein the voice coil actuator controls the rotor assembly to move according to the vibration signal so as to counter the axial vibration.

6. The sensing driver module of claim 5, wherein the accelerometer has a base, a mass block, at least three elastic element sets, a piezoelectric element and a first damping element, the base has a pressing portion on the axial direction, the mass block has a first side and a second side which is opposite to the first side, each of the at least three elastic element sets includes a first elastic element, a second elastic element and a prepressing adjusting element, the first elastic element is arranged on the first side of the mass block, the second elastic element is arranged on the second side of the mass block, the prepressing adjusting element is disposed through the first elastic element, the mass block and the second elastic element, the piezoelectric element is arranged between the mass block and the base, the piezoelectric element has a first side which is toward the pressing portion and a second side which is opposite to the first side, the first damping element is arranged on at least one of two sides of the piezoelectric element, and when the mass block moves on the axial direction, the pressing portion of the base make the piezoelectric element produce a deformation.

7. The voice driver module of claim 5, wherein the voice coil actuator further has a yoke and a positioning frame, the yoke is arranged within the receiving space and annularly arranged around the circumference of the magnetic element, the coil is located between the magnetic element and the yoke, the positioning frame is connected to the cover body and the yoke, and the rotor assembly is located by an inner side of the positioning frame.

8. The sensing driver module of claim 7, wherein the voice coil actuator further has a supporting element and a packing element, the supporting element is annularly arranged around a circumference of the rotor, the supporting element is respectively connected to the rotor and the positioning frame, the packing element is arranged by an inner side of the positioning frame, and the supporting element is sandwiched between the positioning frame and the packing element.

9. The sensing driver module of claim 8, wherein the rotor assembly further has a ball, a locking element and a second elastic element, at least one lateral side of the rotor has a through hole, the ball is arranged within the through hole and abuts against a groove on a side of the pressing element, the locking element is arranged within and tightly fitted into the through hole, and the second elastic element is arranged between the ball and the locking element.

10. The sensing driver module of claim 6, wherein a side of the body base has at least three protrusions and a recess, the accelerometer is tightly fitted into the recess, and the at least three protrusions are evenly arranged.
